(19) United States
(12) Patent Application Publication
(10) Pub. No.: US 2008/0083583 A1
(43) Pub. Date: Apr. 10, 2008

(54) LADDER TOP FOR SUPPORTING A LADDER AGAINST FLAT AND NON-FLAT SURFACES

(75) Inventor: Donald L. GIBSON, Louisville, KY (US)

Correspondence Address: EGBERT LAW OFFICES, 412 MAIN STREET, 7TH FLOOR, HOUSTON, TX, 77002, US

(73) Assignee: Louisville Ladder Group LLC, Louisville, KY (US)

(21) Appl. No.: 11/539,866

(22) Filed: Oct. 9, 2006

(51) Int. Cl. E06C 7/48; E06C 1/00

(52) U.S. Cl. 182/108; 182/194

(57) ABSTRACT

A ladder top has a top panel and a front side in which the front side has a generally V-shaped indentation formed therein. The front side extends downwardly from one side of the top panel. The ladder top has a back side extending downwardly from an opposite side of the top panel. The top panel has at least one recessed pan and a plurality of holes formed thereon. The front side has a plurality of ribs extending thereacross in spaced parallel relation.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to a ladder top. More particularly, the present invention relates to a ladder top versatilely made for holding tools as well as for resting against a variety of shaped surfaces, including but not limited to a flat support surface, the corner of a building, a square pole, a round pole, and trees. The present invention also relates to ladders that are adapted to be used against and supported by such surfaces.

2. Description of Related Art Including Information Disclosed Under 37 CFR 1.97 and 37 CFR 1.98.

Ladders are commonly used as a means for elevating persons to a specified height to perform a specified function. Users of ladders climb a series of steps, or rungs, to reach a desired height. All ladders are finite in height and have a top step which is the highest step and above which no other step exists. Prior art refers to this top step as the ladder top. Ladder tops are typically adapted to fit to the ladder body, which consists of the remaining rungs and any legs of the ladder.

Ladders are typically found in two categories: ladders that have a support means incorporated within the design of the ladder and ladders that use extrinsic surfaces for support. Sometimes, ladders with support means incorporated within their design are folded or used in ways that utilize extrinsic surfaces for support. For ladders that use extrinsic surfaces for support, the ladder top is the only portion of the ladder that actually contacts the extrinsic surface. Further, only a portion of the ladder top actually contacts the extrinsic surface.

Regardless of the ladder type, the only extrinsic surface that safely supports prior art ladder tops is a flat surface, or wall. Surfaces such as round poles, square poles, wall corners, and trees cannot support a ladder because the ladder tops of the prior art will tilt or slip from any non-flat surface.

For example, U.S. Pat. No. 5,259,480, issued on Nov. 9, 1993 to Bartnicki et al., discloses a ladder top for a self-supporting ladder. The ladder top has four side walls and a top panel. The top panel has at least four edges corresponding with each side wall. The four edges connect the top panel to a first, second, third, and fourth side wall. The third and fourth side walls connect the first and second side walls so as to form a rectangular-shaped ladder top. The third and fourth side walls are adapted to connect to the ladder legs. The top panel and first side wall have slots and holes in them so as to act as trays or surfaces for placing equipment, thus enabling a user to better handle tools and paint cans on the ladder top. The second sidewall has a hook from which to hang a can of paint.

U.S. Pat. No. 5,358,070, issued on Oct. 25, 1994 to Bartnicki et al., discloses a ladder top similar to that disclosed in the '480 patent, except that the second side wall has hook. The top panel and first side wall of the ladder top have holes and slots to hang and place tools as desired by the user. One of the holes in the top panel is a large hole that uses crossed-support members running along the diagonal of the bottom of the top panel so as to support a can of paint instead of using a hook as in the '480 patent.

U.S. Pat. No. 5,573,081, issued on Nov. 12, 1996 to Bartnicki et al., discloses a ladder top similar to that disclosed in the '480 and '070 patents, except that the second side wall is limited to having an arcuate depression and a hook. Holes and slots in the top panel and first side wall are used to hang and place tools and equipment as desired by the user. Structural members extend across the bottom of the top panel so as to provide support for a can of paint, and a hook on the second side wall allows the ladder user to hang a paint can from the ladder top. The arcuate depression in the second side wall exists to accommodate the arcuate shape of the bail of a paint bucket as well as move the weight of the bucket closer to the center of the ladder.

U.S. Design Pat. No. 422,717, issued on Apr. 11, 2000 to Bartnicki, et al., discloses a ladder top design. The ladder top design has a top panel and four side walls. The top panel has a surface and an underside. The surface of the top panel is ornamented with a circular recessed area on one side, a rectangular recessed area on the other side, a large slot near the rectangular recessed area, and a small slot near the circular recessed area. The circular recessed area has several levels of recess. The first level is a circle imprinted in the surface of the ladder top. The circle is of a diameter larger than the width of the ladder top. Within the first level of the circular impression is a second level which is a circle with a diameter smaller than that of the first level and also with a hole in the center.

U.S. Design Pat. No. 413,990, issued on Sep. 14, 1999 to Bartnicki, et al., discloses a design for the front face of a ladder top. Specifically, the patent covers a design of six embodiments for the front face of a ladder top. The first embodiment has two horizontal slots cut out of the plastic mold near the top of the wall. Twelve triangular recessed areas are formed so as to make a design for the wall. In the center of the triangular impressions is an elliptical logo. The second embodiment has two horizontal slots cut out of the plastic mold near the top of the wall. Twelve triangular areas are cut out of the plastic mold so as to make a design for the wall. The third embodiment has two horizontal slots cut out of the plastic mold near the top of the wall. Twelve triangular recessed areas are formed so as to make a design for the wall. The fourth embodiment has twelve triangular recessed areas formed so as to make a design for the wall. The fifth embodiment has two horizontal slots cut out of the plastic mold near the top of the wall. Twelve triangular areas are cut out of the plastic mold so as to make a design for the wall. The sixth embodiment has twelve triangular areas cut out of the plastic mold so as to make a design for the wall.

U.S. Design Pat. No. 340,773, issued on Oct. 26, 1993 to Bartnicki, et al., discloses a ladder top design. The ladder top has a top panel and four side walls. The top panel has a surface and an underside. The surface of the top panel has three general sections. The first section is near one side of the top panel and has three holes cut out of the plastic mold. One hole is larger than the other two, and the other two holes are the same size. The middle section has one large hole cut out of the plastic mold, and the second section is near the other side of the top panel and has two holes cut out of the plastic mold. One hole is substantially larger than the other hole. The surface of the top panel has parallel lines that run parallel to the diagonals of the top panel.

All of the above identified ladder tops accommodate only flat extrinsic support surfaces. They do not accommodate non-flat surfaces.

It is an object of the present invention to provide a ladder top.

It is another object of the present invention to provide a ladder top that accommodates both flat and non-flat support surfaces.

It is still another object of the present invention to provide a ladder top that has the ability to hold tools and accessories.

It is another object of the present invention to allow a ladder to be effectively and safely positioned against flat and non-flat support surfaces, such as walls, corners, poles and trees.

These and other objects and advantages of the present invention will be more apparent from a reading of the attached specification and appended claims.

### BRIEF SUMMARY OF THE INVENTION

The present invention is a ladder top that has a top panel and side walls that together form a structure that mounts to the upper ends of the side rails of a ladder while having the ability to hold tools and rest against flat and non-flat supporting surfaces. The side walls include a front side wall that has a generally V-shaped indentation formed therein. This V-shaped indentation will abut a non-flat supporting surface such as a corner, a pole or a tree.

In particular, the top panel will be the top step of the ladder. This top panel has a plurality of openings and channels which serve to receive various tools and supplies therein. In the preferred embodiment of the present invention, a series of multi-sized holes are formed through the top panel adjacent one side of the ladder top. A larger hole is formed inwardly from the series of multi-sized holes. The larger hole is formed through the top panel in a first recessed pan area. An elongated slot is formed through this first recessed pan area generally adjacent the front side of the ladder top. A second recessed pan area is formed adjacent to the first recessed pan area generally centrally of the top panel. The V-shaped indentation extends into this second recessed pan area. A third recessed pan area is formed in the top panel on a side of the second recessed pan area opposite the first recessed pan area. Another elongated slot is formed through the top panel in the third recessed pan area generally adjacent the front side of the ladder top.

The front side of the ladder top has a first portion and a second portion extending in generally coplanar relation on respective opposite sides of the V-shaped indentation. The front side has ribs extending transversely thereto in generally parallel spaced relation to each other. These ribs serve to provide structural integrity to the front side to more securely engage the supporting surface.

The back side of the ladder top extends downwardly from the top panel for a distance greater than a distance that the front side extends downwardly from the top panel. The back side has space thereon suitable for the display of indicia thereon, such as advertising, marketing and safety information.

The interior of the ladder top is suitable for receiving the upper ends of the side rails of the ladder therein. A plurality of criss-crossing ribs are formed on an underside of the top panel so as to enhance the structural integrity of the ladder top.

The ladder top is formed of an injection molded polymeric material. The ladder top is securely mounted to the upper ends of the side rails of the ladder so as to effectively cover the top of the ladder.

The present invention is also an improved ladder having a first side rail and a second side rail with a plurality of rungs extending therebetween. The ladder top is affixed over the upper end of the side rails so as to have a front side facing toward the support surface and a back side facing toward the user. The front side has a V-shaped indentation suitable for engaging the support surface. The back side extends downwardly from a top panel of the ladder top so as to overlie a portion of the first side rail and the second side rail. The back side can include indicia thereon in a position suitable for facing the user.

### BRIEF DESCRIPTION OF THE SEVERAL VIEWS OF THE DRAWINGS

FIG. 1 is a schematic illustration showing a top view of the present invention

FIG. 2 is a perspective view showing the front side of the present invention.

FIG. 3 is another perspective view showing the back side of the present invention.

FIG. 4 is a perspective view of the present invention mounted to the side rails of a ladder.

FIG. 5 is a schematic illustration of the underside of the present invention.

FIG. 6 is a perspective view of the present invention mounted to the rails of a ladder and resting on a corner.

FIG. 7 is a perspective view of the present invention mounted to the rails of a ladder and resting on a pole.

### DETAILED DESCRIPTION OF THE INVENTION

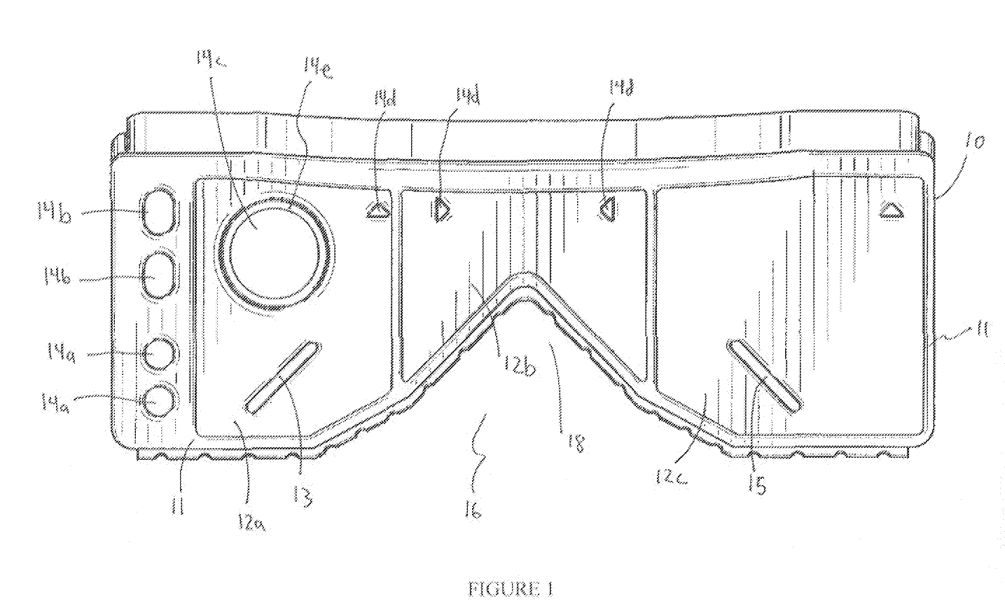

FIG. 1 shows top view of the ladder top contemplated by the present invention. The ladder top has a top panel 10 that has a combination of holes, slots, and recessed areas that enable the ladder top to hold tools and accessories. The top panel 10 is divided into three sections: a first recessed pan 12a, a second recessed pan 12b, and a third recessed pan 12c. The first recessed pan 12a of the top panel 10 has a rim 11 extending therearound and a slot 13 for holding tools and accessories. The first recessed pan 12 has a plurality of holds. Two smaller holes 14a and two larger holes 14b are aligned in series along the rim 11 of the first recessed pan 12a near the edge of the top panel 10. A large hole 14c with a raised lip 14e is positioned inwardly from the two smaller holes 14a and two larger holes 14b. A small hole 14d is positioned in the corner of the first recessed pan 12a near the second recessed pan 12b. The second recessed pan 12b of the top panel 10 is formed adjacent to the first recessed pan 12a and is positioned centrally of the top panel 10. The second recessed pan 12b also has a rim 11 extending therearound. A V-shaped indentation 18 extends into this second recessed pan 12b from the front side 16 of the ladder top. Two small holes 14d are positioned in the corners of the second recessed pan 12b opposing the V-shaped indentation 18 from the front side 16. The third recessed pan 12c is formed adjacent the second recessed pan 12b on a side of the top panel 10 opposite the first recessed pan 12a. The third recessed pan 12c has a rim 11 extending therearound and a slot 15 generally adjacent to the front side wall 16 for holding tools and accessories.

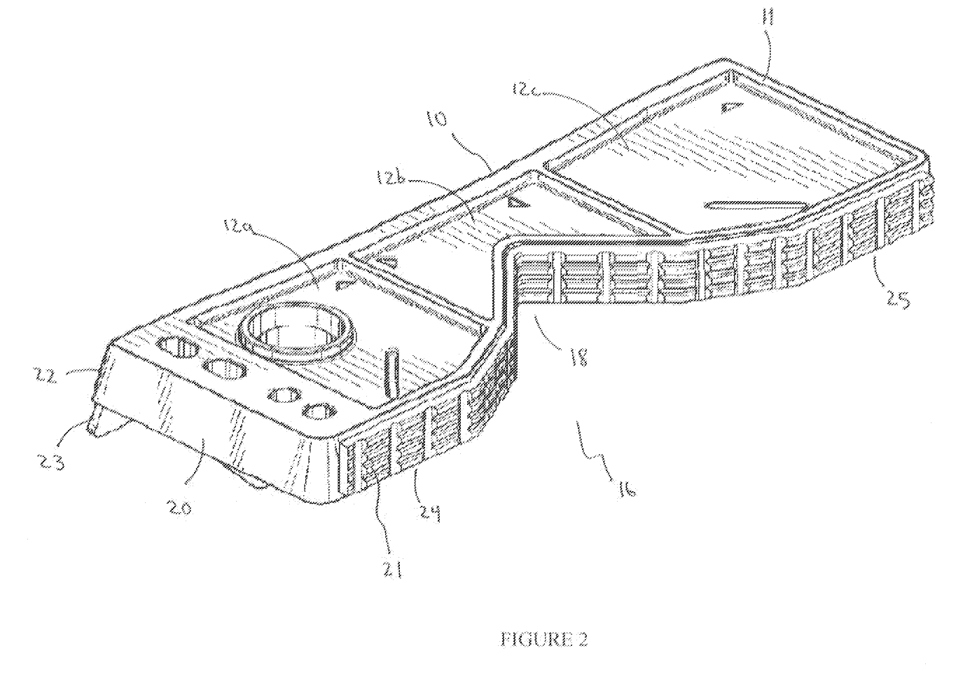

Referring to FIG. 2, the ladder top of the present invention has a front side 16 having a first portion 24 and a second portion 25 extending in generally coplanar relation on respective opposite sides of the V-shaped indentation 18. The front side 16 has ribs 21 extending transversely thereto in generally parallel spaced relation to each other. A first side wall 20 extends perpendicular between the front side 16 and the back 22 of the ladder top. First side wall 20 has a portion 23 near the back 22 that extends downwardly further than the rest of the first side wall 20.

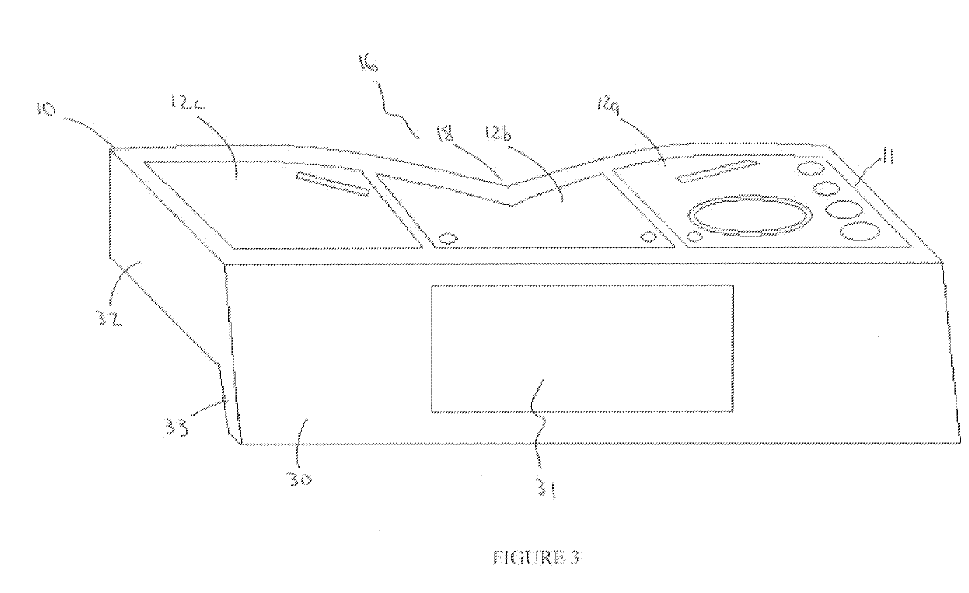

Referring to FIG. 3, the ladder top of the present invention has a back side 30 and a second side wall 32. The back side 30 extends downwardly from the top panel 10 for a distance greater than the distance that the front side 16 extends downwardly from the top panel 10. The back side 30 has a space 31 suitable for display of indicia thereon such as advertising, marketing, and safety information. The second side wall 32 extends perpendicular between the front side 16 and the back side 30 of the ladder top. The second side wall 32 has a portion 33 adjacent the back side 30 that extends downwardly further than the rest of the second side wall 32. The back side 30 also tapers outwardly at an angle greater than ninety degrees with respect to the top panel 10.

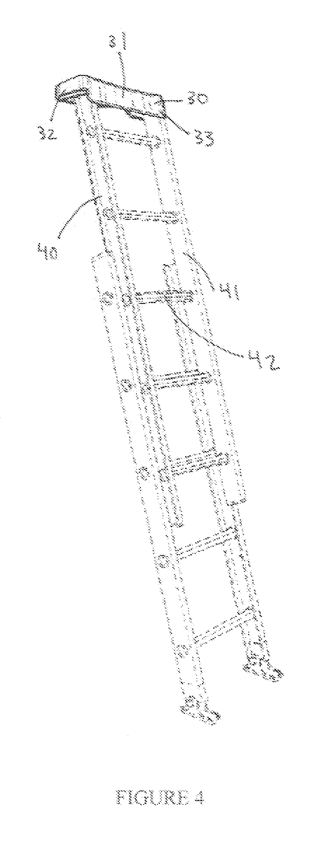

FIG. 4 shows the ladder top of the present invention mounted to the upper end of a first side rail 40 and to the upper end of a second side rail 41 of a ladder. The ladder has rungs 42 extending between the first side rail 40 and second side rail 41.

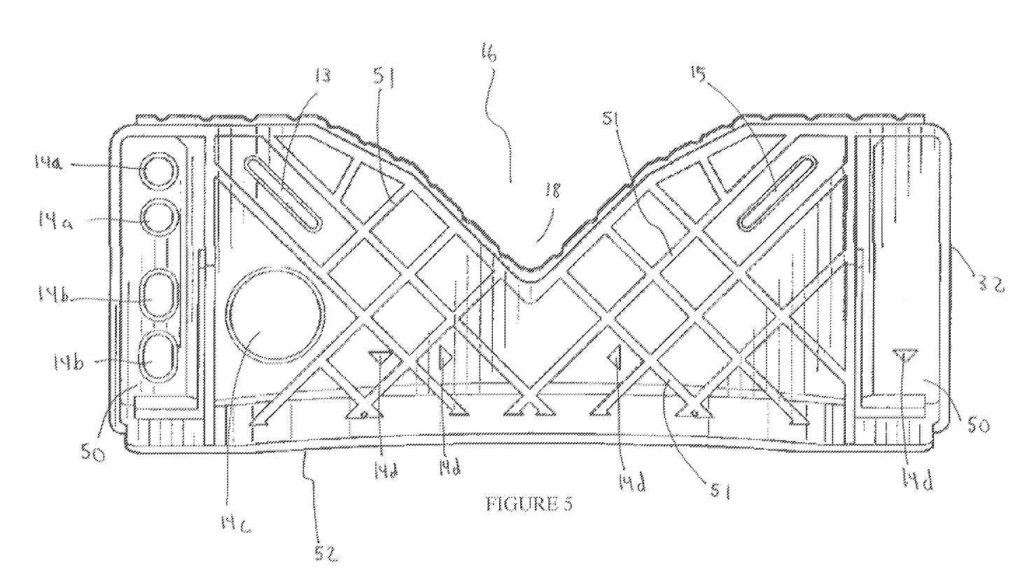

FIG. 5 shows the underside 52 of the ladder top of the present invention. Interior portions 50 near the side walls 20 and 32 of the ladder top are suitable for receiving the upper ends of the side rails 40 and 41 of the ladder therein. A plurality of criss-crossing ribs 51 are formed on the underside 52 so as to enhance the structural integrity of the ladder top.

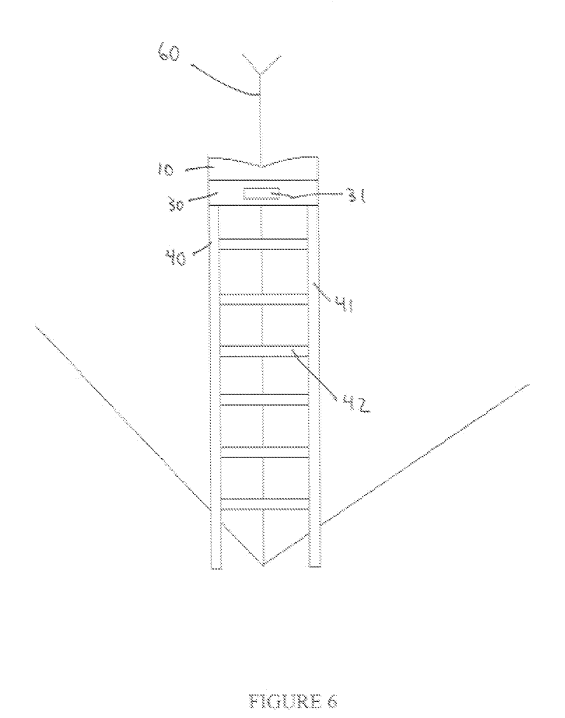

FIG. 6 shows the ladder top of the present invention mounted to the side rails 40 and 41 of a ladder. The ladder top is resting against a corner 60 of a building. In particular it can be seen that the V-shaped indentation of the top panel receives the corner 60. The ribs 21 on the front side 16 create a gripping force against this corner 60 in order to enhance the capacity of the ladder top to retain itself against the corner 60. Because the ladder top is flexible, the front side will tend to “mold” itself around the corner 60 so as to enhance the security and safety of the ladder when it is in such a position.

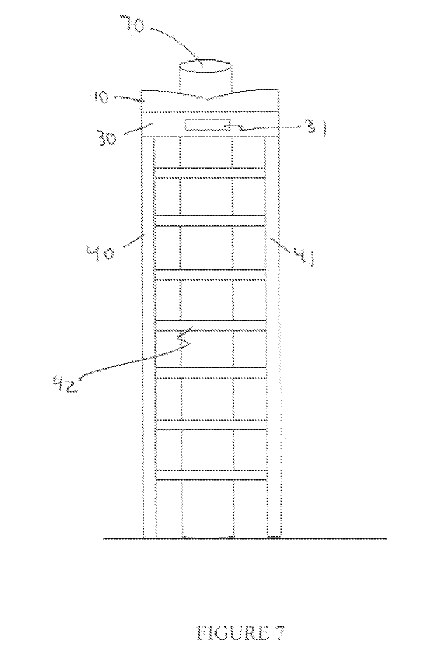

FIG. 7 shows the ladder top of the present invention mounted to the side rails 40 and 41 of a ladder. The ladder top is resting against a round pole 70. In particular it can be seen that the V-shaped indentation of the top panel receives the pole 70. The ribs 21 on the front side 16 create a gripping force against this pole 70 in order to enhance the capacity of the ladder top to retain itself against the pole 70. Because the ladder top is flexible, the front side will tend to “mold” itself around the pole 70 so as to enhance the security and safety of the ladder when it is in such a position.

The foregoing disclosure and description of the invention is illustrative and explanatory thereof. Various changes in the details of the illustrated construction may be made within the scope of the appended claims without departing from the true spirit of the invention. The present invention should only be limited by the following claims and their legal equivalents.

I claim:

1. A ladder top comprising:
a top panel; and
a front side extending downwardly from one side of said top panel, said front side having a generally V-shaped indentation formed therein.

2. The ladder top of claim 1, further comprising:
a back side extending downwardly from an opposite side of said top panel.

3. The ladder top of claim 2, said back side extending angularly outwardly of said top panel, said back side extending downwardly from said top panel for a distance greater than a distance that said front side extends downwardly from said top panel.

4. The ladder top of claim 3, said back side having indicia formed on a surface thereof opposite said front side.

5. The ladder top of claim 1, said top panel having at least one recessed pan formed therein.

6. The ladder top of claim 2, said top panel having a plurality of holes formed therethrough.

7. The ladder top of claim 1, said plurality of holes comprising:
an aligned series of multi-sized holes extending between said front side of said back side, said aligned series of multi-sized holes formed adjacent one end of said top panel.

8. The ladder top of claim 7, said plurality of holes further comprising:
a large diameter hole formed in said top panel inwardly from said aligned series of multi-sized holes, said large diameter hole having a rim extending therearound.

9. The ladder top of claim 7, said plurality of holes further comprising:
an elongated slot formed in said top panel adjacent said front side.

10. The ladder top of claim 5, said at least one recessed pan comprising:
a first pan;
a second pan; and
a third pan, said second pan positioned between said first and third pans, said V-shaped indentation extending into said second pan.

11. The ladder top of claim 1, said front side having a first portion and a second portion in generally coplanar relationship, said V-shaped indentation positioned between said first portion and said second portion.

12. The ladder top of claim 11, said V-shaped indentation having a first generally arcuate section extending to said first portion and a second generally arcuate section extending to said second portion.

13. The ladder top of claim 1, said first side having a plurality of ribs extending transversely thereacross in generally spaced parallel relationships.

14. The ladder top of claim 1, said top panel having a plurality of criss-crossed ribs extending along an underside of said top panel.

15. A ladder comprising:
a first side rail;
a second side rail extending in spaced relation to said first side rail;
a plurality of rungs extending in spaced relation to each other and extending between said first and second side rails; and
a ladder top affixed over an upper end of said first and second side rails, said ladder top having a top panel and a front side, said front side having a generally V-shaped indentation formed therein.

16. The ladder of claim 15, said ladder top having a back side extending downwardly from an upper side of said top panel from said front side, said back side overlying an upper portion of each of said first and second side rails.

17. The ladder of claim 15, said top panel having a plurality of holes formed therethrough.

18. The ladder of claim 15, said top panel having at least one recessed pan formed therein.

19. The ladder of claim 15, said front side having a first portion and a second portion in generally coplanar relationship, said V-shaped indentation positioned between said first portion and said second portion.

20. The ladder of claim 15, said first side having a plurality of ribs extending transversely thereacross in generally spaced parallel relationships.
